(19) United States
(12) Patent Application Publication
(10) Pub. No.: US 2003/0221711 A1
(43) Pub. Date: Dec. 4, 2003

(54) Method for preventing corrosion in the fabrication of integrated circuits

(76) Inventors: Yen-Wu Hsieh, Tao-Yuan Hsien (TW); Chia-Fu Yeh, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,040

(22) Filed: Jun. 4, 2002

(51) Int. Cl. B08B 3/04

(52) U.S. Cl. 134/30

(57) ABSTRACT

An improved post-metal-plasma-etching wafer cleaning process includes providing a wafer having a naked metal structure thereon, dipping the wafer into a first cleaning vessel having a volume of basic solution therein, and after dipping the wafer in the first cleaning vessel, the wafer is then transferred into a second cleaning vessel to perform at least one cycle of a hot QDR cleaning process.

### BACKGROUND OF INVENTION

1. Field of the Invention

The present invention relates to wafer clean processing in the fabrication of integrated circuits. More particularly, this invention relates to an improved wet bench process for preventing corrosion of exposed metal features on a semiconductor wafer.

2. Description of the Prior Art

In the manufacturing of integrated circuits, photoresists are used as an intermediate mask to transfer an original mask pattern of a reticle onto wafer substrates by means of a series of photolithography and plasma etching steps. One of the final steps in the microcircuit manufacturing is removal of the patterned photoresist films from the wafer substrates, which involves exposing a photoresist-coated wafer substrate to oxygen plasma to burn the resist film from the substrate in a process known as oxygen plasma ashing. After the oxygen plasma ashing process, the wafer substrates are transferred to a wet bench station to go through a series of wet cleaning processes for removing plasma etching residues and unwanted substances on the surfaces of the wafers. A conventional wet bench process includes exposing the wafer substrates to certain alkaline solutions, followed by several cycles of a so-called quick-dump-rinse (QDR) process.

The QDR process is carried out in a specially designed QDR tank. In the first cycle of the QDR process, typically, wafer substrates that have been treated with an amine containing wet chemistry solutions are transferred into the QDR tank in which a volume of CO₂-bubbled deionized (DI) water has been loaded at room temperature. The DI water is bubbled with CO₂ for keeping it in a weak acidic state to neutralize basic substances on the surfaces of the wafers. The bath of the first cycle is then terminated by dumping the DI water rapidly via a drain positioned at a bottom of the tank. A second cycle of the QDR process is started by reloading the QDR tank with fresh DI water from the bottom of the tank and, at the same time, from a top of the tank by way of a shower. CO₂ is bubbled during the reloading of the QDR tank.

However, the conventional wafer cleaning process encounters corrosion problems.

Corrosion or micro-corrosion, which is an unintentional removal of metal from a metal film or from a metal surface, results in holes, depressions, voids, or openings being formed in the metal films or the metal surface. These holes, voids, depressions, or openings further result in electrical problems, such as non-contacts, degraded or marginal contacts, and decreased reliability, thereby producing marginal semiconductor devices. Additionally, continual shrinking of geometric features further exacerbates the corrosion problems of these films.

Consequently, a method to reduce corrosion in a simple, inexpensive, and easily-implemented procedure or method would be highly desirable.

### SUMMARY OF INVENTION

Accordingly, it is the primary objective of the claimed invention to provide a wafer cleaning method to dissolve the above-mentioned problems.

Another objective of the claimed invention is to provide a simple, inexpensive, and easily-implemented wet cleaning procedure to prevent metal corrosion, and, at the same time, increase cleaning efficiency.

In accordance with the claimed invention, an improved post-metal-plasma-etching wafer cleaning process is provided. The wafer cleaning process includes providing a wafer having a naked metal structure thereon, dipping the wafer into a first cleaning vessel having a volume of basic solution therein, and after dipping the wafer in the first cleaning vessel, the wafer is then transferred into a second cleaning vessel to perform at least one cycle of a hot QDR cleaning process.

The hot QDR process comprises a step of injecting heated deionized (DI) water into the second cleaning vessel from bottom of the second cleaning vessel. The hot QDR process further comprises a step of bubbling the heated DI water with CO₂ for keeping the heated DI water in a weak acidic state.

These and other objectives of the claimed invention will no doubt become obvious to those of ordinary skill in the art after reading the following detailed description of the preferred embodiment, which is illustrated in the various figures and drawings.

### DETAILED DESCRIPTION

This invention is directed to a wafer processing method for reducing metal corrosion or micro-corrosion. As mentioned, corrosion or micro-corrosion results in holes, depressions, voids, or openings being formed in the metal films or the metal surface. Typically, metal films are used in semiconductor fabrication to make electrically conductive patterns, such as electrically conductive lines and electrically conductive features. The metal surface can be a continuous film or formed into patterns, such as metal lines or features of variously shaped geometries, which shall not be a factor limiting the scope of the present invention. Commonly, the metal surface is deposited onto a surface of a semiconductor wafer. A typical metal film that is used to fabricate metal patterns for semiconductor devices is an aluminum alloy containing a copper additive. Generally, the copper additive ranges from 0.01 percent to 0.5 percent in weight. However, it should be understood that other additives might be used in conjunction with the copper additive.

The addition of the copper impurity to a predominantly aluminum film, while having some benefits, such as hillock reduction and electro-migration reduction, causes severe corrosion problems. Metal surfaces or metal films made of aluminum alloys that have been doped with copper impurities are especially susceptible to corrosion. Corrosion of the naked metal surfaces of the metal films is thought to be due to a formation of a micro-galvanic cell that is established by the aluminum, the copper, and the DI water. Briefly, the micro-galvanic cell is caused by two dissimilar metals in contact with each other, with the aluminum being an anode, the copper being a cathode, and the DI water being a solution in which the reaction takes place.

According to one preferred embodiment of this invention, a wafer substrate with an exposed metal structure is provided. The exposed metal structure may be a patterned metal line or a metal film that is formed by using a plasma dry etching technique to etch a portion of a deposited metal layer that is not covered by a photoresist. By way of example, the metal structure is composed of aluminum alloy that has been doped with copper impurities ranging from 0.01 percent to 0.5 percent in weight, preferably 0.05 percent in weight. It should be understood that the composition of the metal structure described above is exemplary and should not limit the scope of this invention. Other metal compositions that are susceptible to corrosion are also suitable when applying this invention.

The photoresist that is used to define the pattern of the metal structure is then stripped by means of a known oxygen plasma ashing process. Oxygen plasma ashing has become popular in the microcircuit manufacturing process since it is carried out in a vacuum chamber and, hence, is expected to be less susceptible to airborne particulate or metallic contamination. However, oxygen plasma ashing is not fully effective in removing the plasma etching residues noted above.

After removing the photoresist, the wafer substrate is transferred to a batch-type wet bench station comprising a plurality of cleaning tanks. The wafer substrate is firstly placed in a first cleaning tank of the plurality of cleaning tanks. Removal of plasma etching residues on the surface of the wafer substrate is accomplished by exposing the surface of the wafer to certain alkaline amine solutions in the first cleaning tank. Several commercial products are now available to clean the plasma etching residues left by plasma etching followed by oxygen ashing. For example, EKC 265, obtained from EKC Technology, Inc., is a cleaning solution composed of water, alkanolamine, catechol, and hydroxylamine. Thereafter, the wafer substrate is moved out from the first cleaning tank and transferred to a second cleaning tank, namely “QDR” tank. It should be noted that between the first cleaning tank and the QDR tank, there is commonly provided a third cleaning tank in which a volume of N-methyl-2-pyrrolidone (NMP) containing solution is loaded for cleaning the wafer substrate prior to the QDR tank. NMP, as known by those skilled in the art, is able to neutralize basic substances dissolved in an organic phase on the surface of the wafer substrate.

The structure of the QDR tank is similar to a conventional QDR tank known in the art, and is therefore not discussed in detail. Briefly, a rapid dumping system and a water intake system are normally installed at the bottom of the QDR tank. At least one set of CO₂ bubbling tubes is provided in the QDR tank for bubbling the DI water injected into the QDR tank. Further, a scrubber is normally installed over the QDR tank. According to a prior art method, DI water is sprayed directly onto wafer surfaces.

In accordance with the present invention, when proceeding with the first cycle of a QDR cleaning process, a volume of “hot” DI water has been loaded in the QDR tank before the wafer substrate is transferred to the QDR tank. The temperature of the hot DI water is approximately between 70° C. to 80° C. The hot DI water is continuously bubbled with CO₂. The hot DI water may be provided either by heating the source of the DI water or by adding a heating jacket along the DI water piping. The main purpose of using hot DI water is to reduce the dissolved oxygen concentration of the volume of DI water in the QDR tank. The dissolved oxygen is believed to accelerate the micro-galvanic corrosion during the cycles of the QDR cleaning process. Since the concentration of dissolved oxygen in water reduces when the temperature of the water rises, a volume of hot DI water that is heated to a temperature of about 70° C. to 80° C. can effectively reduce corrosion down to an acceptable level.

Likewise, the bath of the first cycle is then terminated by dumping the hot DI water rapidly via the rapid dumping system positioned at the bottom of the tank. A second cycle of the QDR process is started by reloading the empty QDR tank with fresh hot DI water from the bottom of the QDR tank. CO₂ is bubbled during the reloading of the QDR tank. At this phase, however, the scrubber over the QDR tank is turned off. In fact, the scrubber is turned off through the entire QDR cleaning process according to the present invention. This is because the spray of the DI water through the scrubber will “pump” air into the DI water and thus results in increased concentration of dissolved oxygen. In other words, the reloading of the hot DI water is carried out only from the bottom of the QDR tank. After the second cycle, a third cycle of QDR cleaning process may go on. The third cycle of QDR cleaning process, if required, has exactly the same dump-reload steps as the second cycle and also uses hot DI water to rinse the wafer surfaces.

After the QDR cleaning process, the wafer substrate is moved out from the QDR tank and then is normally transferred to a fourth cleaning tank in which a volume of fresh DI water is loaded. According to one preferred embodiment of this invention, the water overflows in the fourth cleaning tank and is kept at room temperature for accommodating the wafer conditions with a subsequent “IPA” drying procedure known in the art. Here, the room temperature means a temperature of about 20° C. to 30° C. Since the QDR cleaning process uses hot DI water through the cycles of QDR cleaning process, it is also referred to as a “hot QDR cleaning process”.

In contrast to the prior art method, a “hot QDR cleaning process” is used to replace a conventional “room temperature QDR cleaning process”. Since the dissolved oxygen is minimized by raising the bath temperature to a range of 70° C. to 80° C., corrosion is prevented. Further, the “hot QDR cleaning process” of this invention is carried out without using a scrubber normally positioned over the QDR tank. Plus, the cleaning efficiency of wafers is increased according to this invention.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A post-metal-plasma-etching wafer cleaning process, comprising:
providing a wafer having a naked metal structure thereon;
dipping the wafer into a first cleaning vessel having a volume of basic solution therein; and
after dipping the wafer in the first cleaning vessel, the wafer is then transferred into a second cleaning vessel to perform at least one cycle of a hot quick-dump-rinse (hot QDR) process.

2. The post-metal-plasma-etching wafer cleaning process of claim 1 wherein the hot QDR process comprises a step of injecting heated deionized (DI) water into the second cleaning vessel from bottom of the second cleaning vessel.

3. The post-metal-plasma-etching wafer cleaning process of claim 2 wherein the hot QDR process further comprises a step of bubbling the heated DI water with CO₂ for keeping the heated DI water in a weak basic state.

4. The post-metal-plasma-etching wafer cleaning process of claim 2 wherein the DI water injected into the second cleaning vessel is heated to a temperature of about 70° C. to 80° C.

5. The post-metal-plasma-etching wafer cleaning process of claim 1 wherein the volume of basic solution is a volume of amine-based basic solution.

6. The post-metal-plasma-etching wafer cleaning process of claim 1 wherein the hot QDR process is carried out without using a scrubber positioned over the second cleaning vessel.

7. A method for preventing corrosion in the fabrication of integrated circuits, comprising:
providing a wafer having a naked metal structure thereon; and
executing a wet bench process over the wafer, comprising:
dipping the wafer in a basic solution;
performing a post-strip-rinse process after dipping the wafer in the basic solution;
performing at least one cycle of a hot quick-dump-rinse (hot QDR) process; and
performing a deionized water (DI) overflow final rinse at room temperature.

8. The method of claim 7 wherein the hot QDR process is carried out in a QDR tank.

9. The method of claim 8 wherein the hot QDR process comprises a step of injecting heated DI water into the QDR tank from bottom of the QDR tank.

10. The method of claim 8 wherein the DI water injected into the QDR tank is heated to a temperature of about 70° C. to 80° C.

11. The method of claim 7 wherein the basic solution is amine-based basic solution.

12. The method of claim 7 wherein post-strip-rinse process utilizes NMP (N-methyl-2-pyrrolidone) containing solution.

13. The method of claim 7 wherein the hot QDR process is carried out without using a scrubber positioned over the QDR tank.

14. The method of claim 7 wherein the room temperature is approximately between 20° C. and 30° C.
